(19) United States
(12) Patent Application Publication
(10) Pub. No.: US 2016/0003669 A1
(43) Pub. Date: Jan. 7, 2016

(54) OPTICAL FIBER VIBRATION SENSOR AND METHOD OF MEASURING VIBRATION USING THE SAME

(71) Applicant: Pukyong National University Industry-University Cooperation Foundation, Busan (KR)

(72) Inventors: Yong Wook LEE, Busan (KR); Young Suk KIM, Busan (KR)

(21) Appl. No.: 14/330,895

(22) Filed: Jul. 14, 2014

(30) Foreign Application Priority Data
Jul. 7, 2014 (KR) 10-2014-0084595

(51) Int. Cl. G01H 9/00

(52) U.S. Cl. CPC G01H 9/004

(57) ABSTRACT

An optical fiber vibration sensor includes a polarization-diversity loop based interference unit having a polarization-maintaining fiber configured to generate an interference spectrum, a polarizing beam splitter connected to the polarization-maintaining fiber and configured to split light incident from a narrowband light source into two polarized beams, and a polarization controller connected to the polarization-maintaining fiber or the polarizing beam splitter and configured to control the two polarized beams split through the polarizing beam splitter, and an optical fiber vibration test unit combined to the polarization-maintaining fiber so as to apply an external vibration to the polarization-maintaining fiber, wherein light output intensity of the polarization-diversity loop based interference unit is converted to an electrical signal by a light detector, and the vibration applied to the polarization-maintaining fiber may be measured through the optical fiber vibration test unit.

### CROSS-REFERENCE TO RELATED APPLICATION

This application claims priority to and the benefit of Korean Patent Application No. 10-2014-0084595, filed on Jul. 7, 2014, the disclosure of which is incorporated herein by reference in its entirety.

### BACKGROUND

1. Field of the Invention

The present invention relates to an optical fiber vibration sensor and a method of measuring a vibration using the same, and more particularly, to an optical fiber vibration sensor capable of converting an optical output signal to an electrical signal and measuring a vibration, and a method of measuring the vibration using the same.

2. Description of the Related Art

Since optical fiber vibration sensors have long-term durability and convenience of use, many studies regarding optical fiber vibration sensors have been achieved. Various methods, such as a method of measuring a wavelength variation of an optical spectrum, a method of measuring a light intensity variation, a method of analyzing a vector of output light, and the like, have been proposed as methods for measuring a vibration of the optical fiber vibration sensor.

Major research issues in the optical fiber vibration sensors are their strength with respect to transverse stress, stability with respect to external temperature variations, measurable oscillation frequency bandwidth, sensitivity with respect to vibration, and the like, and the following conventional optical fiber vibration sensors have been proposed to try to resolve these issues.

For example, an optical fiber vibration sensor based on a fiber grating has been developed. When a vibration is applied to the fiber grating using a fiber Bragg grating or a long-period fiber grating as a sensor unit, methods for measuring the size of the vibration by measuring the variation of the wavelength or intensity (i.e., transmittance and reflectance) variation of a peak or a dip in a spectrum reflected or transmitted by the vibration have been proposed.

However, a precise manufacturing device using a laser is essential to manufacture the fiber grating, and the fiber grating used as the sensor unit is very weak against the transverse stress compared to general optical fibers.

Further, since the fiber grating has cross sensitivity with respect to an ambient temperature variation, vibrations measurements are not available at points where temperature variations are severe. In addition, temperature compensation processes are certainly required in order to use the fiber grating.

### SUMMARY

The present invention is directed to an optical fiber vibration sensor capable of converting an optical output signal to an electrical signal and measuring a vibration, and a method of measuring a vibration using the same.

According to an aspect of the present invention, provided is an optical fiber vibration sensor, including: a polarization-diversity loop-based interference unit having a polarization-maintaining fiber configured to generate an interference spectrum, a polarizing beam splitter connected to the polarization-maintaining fiber and configured to split light incident from a narrowband light source into two polarized beams, and a polarization controller connected to the polarization-maintaining fiber or the polarizing beam splitter and configured to control the two polarized beams split through the polarizing beam splitter; and an optical fiber vibration test unit combined to the polarization-maintaining fiber so as to apply an external vibration to the polarization-maintaining fiber, wherein light output intensity of the polarization-diversity loop-based interference unit is converted to an electrical signal by a light detector, and the vibration applied to the polarization-maintaining fiber may be measured through the optical fiber vibration test unit.

In one embodiment, the optical fiber vibration test unit includes a piezoelectric device as a vibration source of the polarization-maintaining fiber, and an auxiliary structure fixed to both ends of the piezoelectric device so as to transmit a vibration generated from the piezoelectric device to the polarization-maintaining fiber, wherein the piezoelectric device is connected to a control unit using a power terminal as a medium, wherein a volume of the piezoelectric device may be temporally changed according to an alternating waveform when a voltage having the alternating waveform is input from the control unit.

In another embodiment, the auxiliary structure is provided in a U-shape, wherein the auxiliary structure may include one or more materials among stainless steel, chromium (Cr), carbon (C), Teflon, iron (Fe), copper (Cu), titanium (Ti), aluminum (Al), zinc (Zn), nickel (Ni), brass, mica, and an alloy thereof.

In still another embodiment, the polarization-maintaining fiber, the polarizing beam splitter, and the polarization controller are connected to each other through the optical fiber, wherein the optical fiber may be connected using any one method among fusion splicing, an optical fiber patch cord, and a mechanical splicer.

In yet another embodiment, the optical fiber may include one or more fibers among a single-mode fiber, a multi-mode step-index fiber, a multi-mode graded-index fiber, and a high numerical aperture multi-mode fiber.

In yet another embodiment, the optical fiber may include one or more fibers among a silica based fiber, a fluorine based fiber, a rare-earth material-based fiber, a polymer-based fiber, and a flint glass fiber.

In yet another embodiment, the optical fiber may include one or more fibers among a photonic crystal fiber, a multi-core fiber, a twisted fiber, an etched fiber, a tapered fiber, a lensed fiber, and a metal-coated fiber.

In yet another embodiment, the optical fiber may include one or more fibers among a polarization-maintaining fiber, a nonlinear fiber, a dispersion-shifted fiber, a dispersion compensation fiber, and a non-zero dispersion-shifted fiber.

In yet another embodiment, the polarization controller may include a bulk-type polarization controller or an optical fiber-type polarization controller.

In yet another embodiment, according to a method of measuring a vibration using the above-described optical fiber vibration sensor, light output intensity of the polarization-diversity loop based interference unit is converted to an electrical signal by a light detector and is measured, and a vibration applied to the polarization-maintaining fiber may be measured through the optical fiber vibration test unit.

### BRIEF DESCRIPTION OF THE DRAWINGS

The above and other embodiments of the present invention will become more apparent to those of ordinary skill in the art by describing in detail exemplary embodiments thereof with reference to the accompanying drawings, in which:

FIG. 1 is a conceptual view of an optical fiber vibration sensor according to an embodiment of the present invention;

FIG. 2 is a conceptual view showing an optical fiber vibration test unit excerpt from FIG. 1;

FIG. 3 is a graph showing a multi-wavelength transmission spectrum of a polarization-diversity loop-based interference unit measured with a broadband light source, and a multi-wavelength transmission spectrum measured from the polarization-diversity loop-based interference unit when a longitudinal strain is applied to a polarization-maintaining fiber; and

FIGS. 4A to 4F are graphs showing the values for measuring a light intensity variation output from the polarization-diversity loop-based interference unit using a light detector and an oscilloscope when a frequency applied to the polarization-maintaining fiber is adjusted in a range of 1 to 4000 Hz.

### DETAILED DESCRIPTION

Exemplary embodiments of the present invention will be described in detail below with reference to the accompanying drawings. However, the present invention may be made in many different forms, and thus the present invention is not limited to the described embodiments. Further, detailed descriptions of well-known functions or configurations that unnecessarily obscure the gist of the invention in the following explanations and accompanying drawings will be omitted for a more precise description, and the same reference numbers will be used throughout this specification to refer to the same or like parts.

Throughout this specification, when an element is referred to as being “connected” to another element, the element can be “directly connected” to the other element or “indirectly connected” to the other element with other intervening element(s). Further, when a certain part “includes” a certain component, it does not exclude cases in which other components are included unless otherwise defined.

Hereinafter, exemplary embodiments of the present invention will be described in detail with reference to the accompanying drawings.

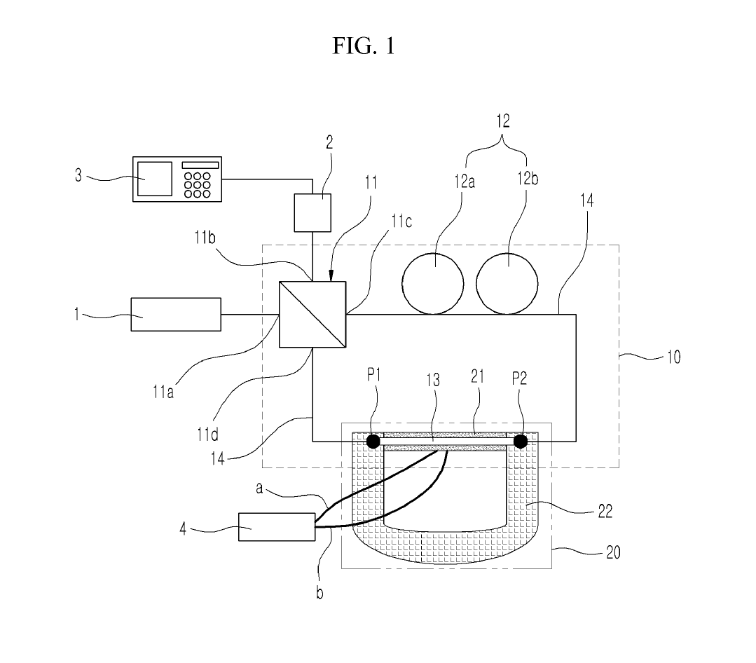

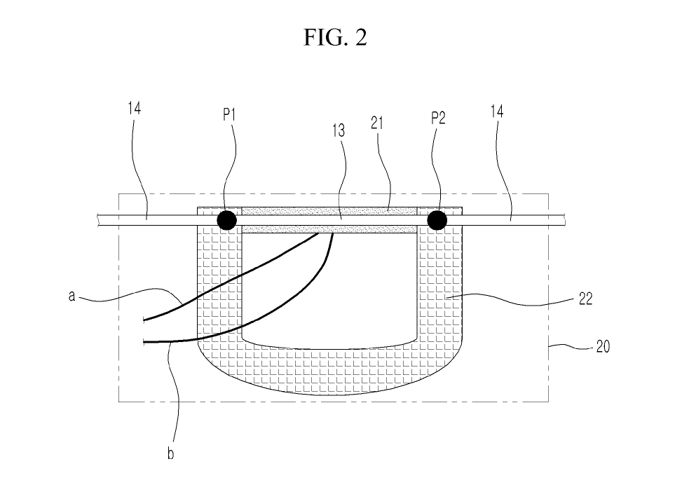

FIG. 1 is a conceptual view of an optical fiber vibration sensor according to an embodiment of the present invention, and FIG. 2 is a conceptual view showing an optical fiber vibration test unit excerpt from FIG. 1.

As shown in FIGS. 1 and 2, the optical fiber vibration sensor according to one embodiment of the present invention includes a polarization-diversity loop-based interference unit 10 and an optical fiber vibration test unit 20.

The polarization-diversity loop based interference unit 10 includes a polarization-maintaining photonic crystal fiber 13—hereinafter called a polarization-maintaining fiber—configured to generate an interference spectrum, a polarizing beam splitter 11 connected to the polarization-maintaining fiber 13 and configured to split light incident from a narrowband light source 1 into two polarized beams, and a polarization controller 12 connected to the polarization-maintaining fiber 13 or the polarizing beam splitter 11 and configured to control the two polarized beams split through the polarizing beam splitter 11.

The polarization-maintaining fiber 13 included in the polarization-diversity loop-based interference unit 10 may use a polarization-maintaining large-mode area fiber, a polarization-maintaining photonic crystal fiber, or the like, according to whether a stress-induced element is included or not.

Further, the polarization-maintaining fiber 13 may use a photonic crystal fiber in which two or more air holes, having different sizes from the air holes in the vicinity, are included therein, according to a structure of the air holes arranged around a core, in order to induce birefringence from the polarization-maintaining fiber, a photonic crystal fiber in which the diameters of the air holes having different sizes from the air holes in the vicinity are in a range of 0.1 to 50 μm, a photonic crystal fiber in which intervals between the air holes having different sizes from the air holes in the vicinity are in a range of 0 to 20 μm, etc.

The polarizing beam splitter 11 is connected to the polarization-maintaining fiber 13 and has a polarizer (not shown) to split light incident from the narrowband light source 1 into two polarized beams. The polarizer is used to divide an input light source into two components of light having vertical and horizontal polarization components, which are perpendicular to each other.

The polarizer of the polarizing beam splitter 11 includes a first, second, third and fourth terminals 11a, 11b, 11c, and 11d. The first terminal 11a is connected to the narrowband light source 1 and used as an input of the polarization-diversity loop-based interference unit 10. The second terminal 11b of the polarizing beam splitter 11 is used as an output of the polarization-diversity loop-based interference unit 10 and connected to a light detector 2. The third terminal 11c of the polarizing beam splitter 11 outputs the horizontal polarization component of light input to the first terminal 11a. The fourth terminal 11d of the polarizing beam splitter 11 outputs the vertical polarization component of the light input to the first terminal 11a.

The polarization controller 12 is connected to the polarization-maintaining fiber 13 or the polarizing beam splitter 11 and an optical fiber 14, and may be formed by a half wavelength plate 12a or a quarter wavelength plate 12b to control the two polarized beams split by the polarizing beam splitter 11.

Further, the polarization controller 12 is provided in a bulk-type or in an optical fiber-type, and may be formed by the half wavelength plate 12a, the quarter wavelength plate 12b, or a combination thereof.

The optical fiber vibration test unit 20 is combined with the polarization-maintaining fiber 13 to apply an external vibration to the polarization-maintaining fiber 13.

The optical fiber vibration test unit 20 includes a piezoelectric device 21 as a vibration source of the polarization-maintaining fiber 13, and an auxiliary structure 22 fixed to both ends of the piezoelectric device 21 so as to transmit a vibration generated from the piezoelectric device 21 to the polarization-maintaining fiber 13.

The piezoelectric device 21 is connected to a control unit 4 using power terminals (a) and (b) as media, wherein a volume of the piezoelectric device 21 may be temporally changed according to an alternating waveform when a voltage having the alternating waveform is input from the control unit 4.

The auxiliary structure 22 is provided in a U-shape, wherein the auxiliary structure may include one or more materials among stainless steel, chromium (Cr), carbon (C), Teflon, iron (Fe), copper (Cu), titanium (Ti), aluminum (Al), zinc (Zn), nickel (Ni), brass, mica, and an alloy thereof.

The polarization-maintaining fiber 13 used as a sensor unit is connected with the optical fiber 14 by a fusion splicing method, and fusion splice points P1 and P2 and both ends of the piezoelectric device 21 may be fixed to the auxiliary structure 22 having a U-shape using an adhesive member as a medium.

Since the piezoelectric device 21 is connected to the control unit 4 using the power terminals (a) and (b) as media, a volume thereof electrically varies via the control unit 4, and the volume of the piezoelectric device 21 may be temporally changed according to an alternating waveform when a voltage having the alternating waveform is input from the control unit 4.

When a vibration is applied to the polarization-maintaining fiber 13 fixed as described above using the piezoelectric device 21 as a medium, a tension, having a time-varying intensity, of a longitudinal direction is applied to the polarization-maintaining fiber 13, whereby birefringence of the polarization-maintaining fiber 13 is changed by the applied tension, and thus a wavelength transition may occur in a multi-wavelength spectrum output from the polarization-diversity loop-based interference unit 10.

Since the input light source is the narrowband light source 1, a wavelength variation of the interference spectrum is converted to a light intensity variation. After the light intensity variation is converted to an electric signal (i.e., voltage) through the light detector 2, a temporal variation of the electric signal is observed using an oscilloscope 3, and thus a vibration received from the outside may be measured.

That is, a light output intensity of the polarization-diversity loop-based interference unit 10 is converted to an electric signal by the light detector 2, and a vibration applied to the polarization-maintaining fiber 13 may be measured through the optical fiber vibration test unit 20.

The optical fiber 14 is provided to connect the polarization-maintaining fiber 13, the polarizing beam splitter 11, and the polarization controller 12 to each other, and the optical fiber 14 may be connected using any one method among fusion splicing, an optical patch cord, and a mechanical splicer.

The optical fiber 14 may be configured by any one of among the various types classified by a structure of the optical fiber 14, a material of the optical fiber 14, a method of manufacturing the optical fiber 14, and an optical characteristic of the optical fiber 14, or a combination thereof.

First, the optical fiber 14 may include one or more fibers among a single-mode fiber, a multi-mode step-index fiber, a multi-mode graded-index fiber, and a high numerical aperture multi-mode fiber according to the structure thereof.

The optical fiber 14 according to one embodiment of the present invention is applied as a single-mode optical fiber 14, and the single-mode optical fiber 14 has a cut-off frequency in which light may be guided in a single mode by connecting optical components.

The optical fiber 14 may include one or more fibers among a silica-based fiber, a fluorine-based fiber, a rare-earth material-based fiber, a polymer-based fiber, and a flint glass fiber according to the material thereof.

The optical fiber 14 may include one or more fibers among a photonic crystal fiber, a multi-core fiber, a twisted fiber, an etched fiber, a tapered fiber, a lensed fiber, and a metal-coated fiber according to the method of manufacturing the same.

Finally, the optical fiber 14 may include one or more fibers among a polarization-maintaining fiber, a nonlinear fiber, a dispersion-shifted fiber, a dispersion compensation fiber, and a non-zero dispersion-shifted fiber according to the optical characteristic thereof.

All types of light sources—including an electromagnetic wave—may basically be applied as the narrowband light source 1 to be used as the optical fiber vibration sensor according to the embodiment of the present invention.

Generally, principles wherein light is generated include electroluminescence, which induces light emission by applying an electric field to a luminescent material, photoluminescence, which generates light having a longer wavelength by applying ultraviolet, blue, or green light, or the like, to a phosphor, cathodoluminescence, which emits light by colliding high-energy electrons, an electron-hole recombination, which emits light by recombining electrons and holes, etc.

The narrowband light source 1 which may be applied as an optical fiber vibration sensor may be implemented by any one method of the above-described light-emitting principles, and light including an electromagnetic wave having any one wavelength band among the wavelength bands of ultraviolet rays, visible rays, and infrared rays may be output. For example, the narrowband light source 1 may include a light-emitting diode, an organic light-emitting diode, solar light, fluorescent light, incandescent light, a laser, or the like.

Specifically, all types of lasers having the characteristic of a narrowband wavelength may be used as a light source for the optical fiber vibration sensor. The laser may include a solid-state laser, such as a ruby laser and a neodymium-doped yttrium aluminum garnet (Nd-YAG) laser, a semiconductor laser, such as a distributed feedback laser diode and a distributed Bragg reflector laser diode, a gas laser, such as an argon (Ar) laser, a carbon dioxide (CO2) laser, a helium-neon (He—Ne) laser, an excimer laser, a liquid laser, such as a dye laser, and the like.

Next, the experimental results for measuring vibrations using the optical fiber vibration sensor according to one embodiment of the present invention will be described. Further, a description with reference to the configuration of the optical fiber vibration sensor according to the present invention, based on FIGS. 1 and 2 described above will be provided.

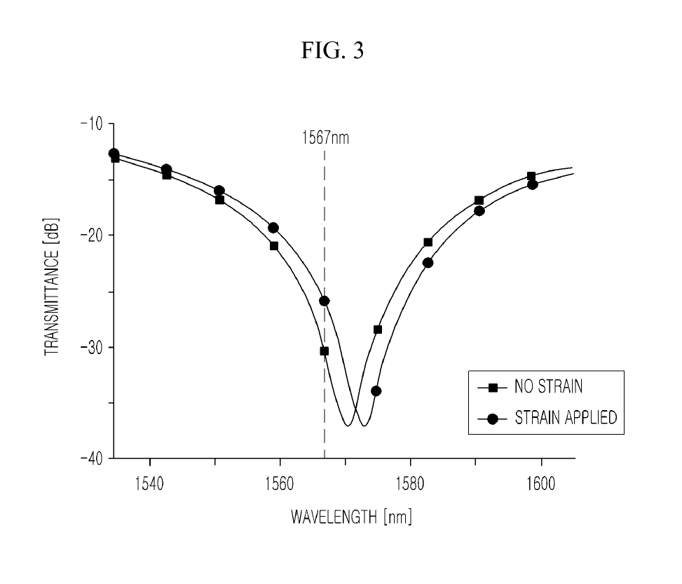

FIG. 3 is a graph showing a multi-wavelength transmission spectrum of the polarization-diversity loop-based interference unit 10 measured with a broadband light source, and a multi-wavelength transmission spectrum measured from the polarization-diversity loop-based interference unit 10 when a longitudinal strain is applied to the polarization-maintaining fiber 13.

FIG. 3 shows the result of measuring an interference spectrum of the polarization-diversity loop-based interference unit 10 in a range of 1535 to 1605 nm using a broadband light source. When measured in a wider range, a periodic spectrum may be determined.

Spectra with circular and square symbols as shown in FIG. 3 represent measured spectra when a uniform strain of 1 mε is applied and not applied to the polarization-maintaining fiber 13 in a longitudinal direction, respectively. Here, 1 mε means a strain applied to the polarization-maintaining fiber 13 when the polarization-maintaining fiber 13 having a 1 m length extends by 1 mm.

As shown in FIG. 3, when the longitudinal strain is applied to the polarization-maintaining fiber 13, it may be seen that a transition of the interference spectrum towards a longer wavelength occurs.

For example, when the narrowband light source 1 having a center wavelength of 1567 nm is input to the polarization-diversity loop-based interference unit 10, the output light intensity of the polarization-diversity loop-based interference unit 10 is increased when a longitudinal strain is applied to the polarization-maintaining fiber 13.

When a longitudinal vibration is applied to the polarization-maintaining fiber 13, it may be predicted that the intensity of the longitudinal strain applied to the polarization-maintaining fiber 13 is temporally changed. Thus, it may be seen that the output light intensity of the polarization-diversity loop-based interference unit 10 may also be temporally changed.

Therefore, when the narrowband light source 1 is used as an input light source in the polarization-diversity loop-based interference unit 10 including the polarization-maintaining fiber 13, a wavelength variation of the interference spectrum may be converted to a light intensity variation, and the light intensity variation may be converted to a variation of an electric signal (i.e., voltage) through the light detector 2. And then, when a temporal variation of the electric signal is measured using the oscilloscope 3, an external vibration applied to the polarization-maintaining fiber 13 may be measured.

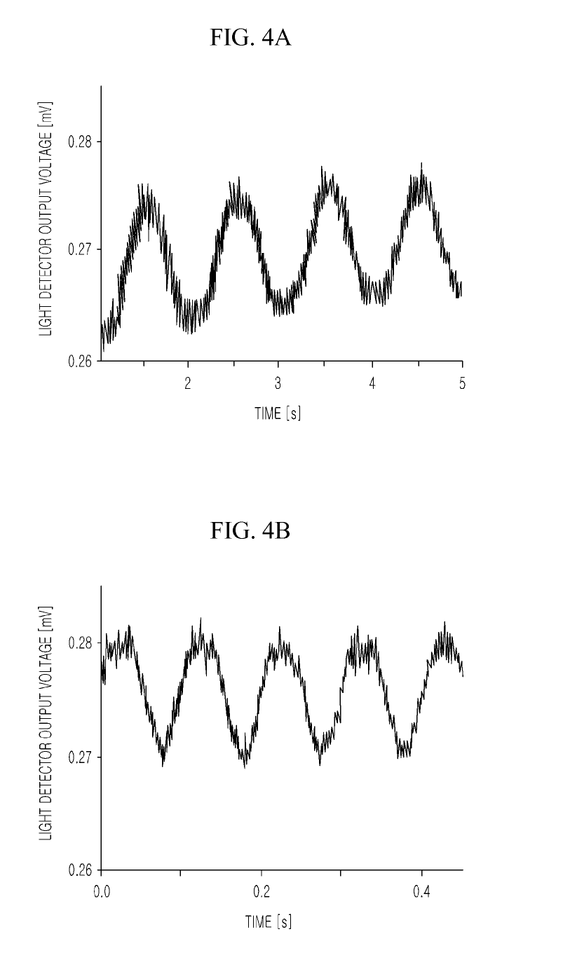

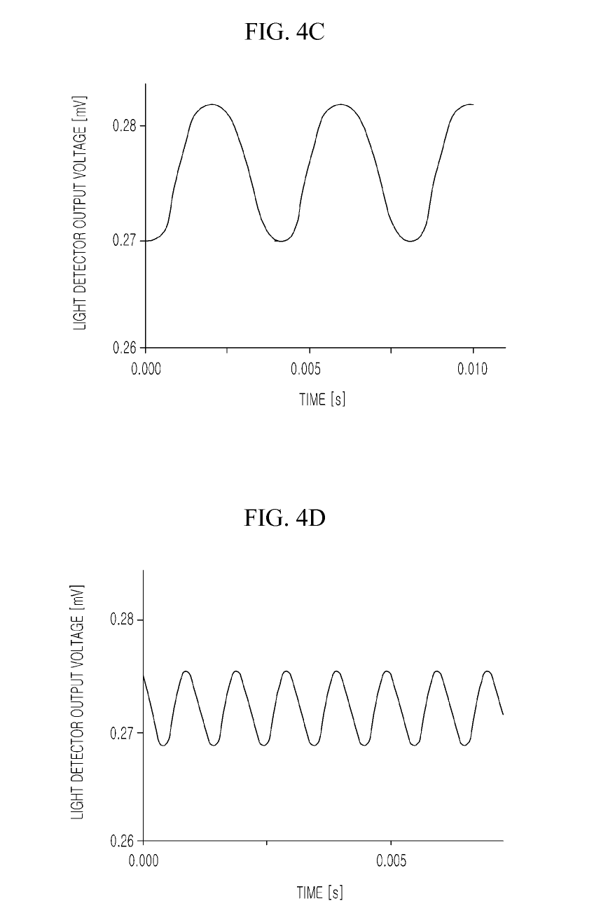

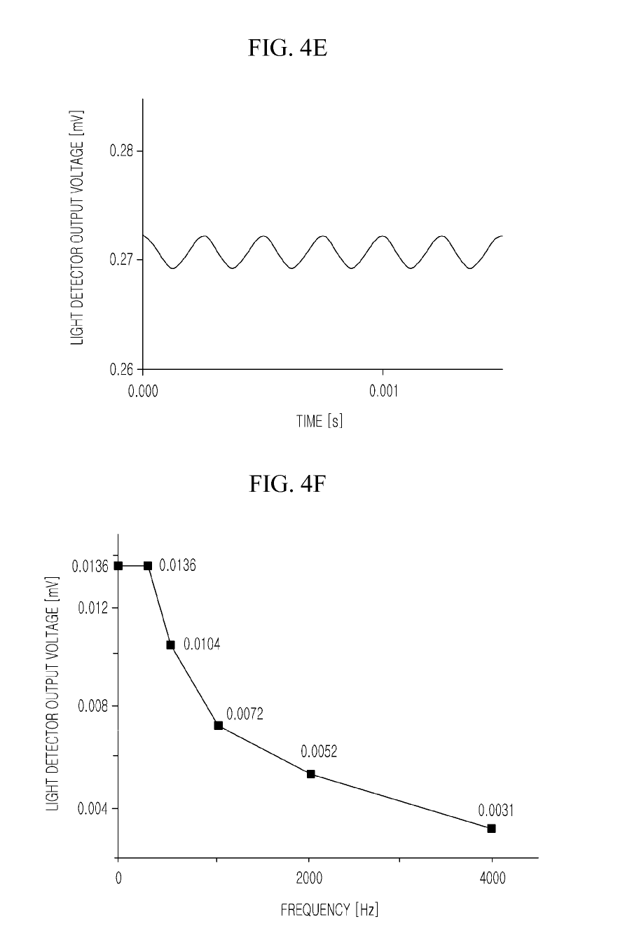

FIGS. 4A to 4F are graphs showing the values for measuring a light intensity variation output from the polarization-diversity loop-based interference unit 10, using a light detector and an oscilloscope, when a frequency applied to the polarization-maintaining fiber 13 is adjusted in a range of 1 to 4000 Hz.

FIGS. 4A to 4F show the results of measuring a variation of light intensity output from the polarization-diversity loop-based interference unit 10 using the light detector 2 and the oscilloscope 3 when a longitudinal vibration in a sinusoidal wave-type is applied to the polarization-maintaining fiber 13 in the range of 1 to 4000 Hz using the piezoelectric device 21.

FIGS. 4A to 4E show the output signals for a sensor in which a frequency of a longitudinal vibration applied to the polarization-maintaining fiber 13 is 1, 10, 250, 1000, or 4000 Hz, respectively, and FIG. 4F shows the size variation of the output signal of the sensor according to the applied vibration frequency.

As shown in FIGS. 4A to 4E, it may be seen that an output signal of a waveform similar to the applied vibration waveform (i.e., a sine wave) is measured, and the amplitude of the output signal is reduced while increasing the applied vibration frequency.

Further, as shown in FIG. 4F, it may be seen that the size of the output signal at the applied vibration frequency of 4000 Hz is reduced to 22% or less compared to that at a frequency of 250 Hz.

Therefore, when a high frequency vibration is measured, it may be predicted that a cut-off frequency that is a measurable frequency limit will be different according to the type of the polarization-maintaining fiber 13 to be used as a sensor, and the type of the auxiliary structure 22 that completely transmits an external vibration to the polarization-maintaining fiber 13.

Therefore, as shown FIGS. 1 to 4F, as the optical fiber vibration sensor according to the present invention includes the polarization-diversity loop-based interference unit 10 and the optical fiber vibration test unit 20, a measurable vibration frequency bandwidth may extend to 4000 Hz, and a characteristic insensitive to the ambient temperature may be included in the polarization-maintaining fiber 13 of a single material that serves as a sensor unit.

Further, there is no need to manufacture a fiber grating as an optical fiber vibration sensor based on a fiber grating, and the polarization-maintaining fiber 13 has a strong characteristic against transverse stress compared to a fiber grating manufactured via an ultraviolet exposing process.

According to the embodiments of the present invention, as the optical fiber vibration sensor includes the polarization-diversity loop-based interference unit and the optical fiber vibration test unit, a measurable vibration frequency bandwidth can extend up to 4000 Hz, and a characteristic insensitive to ambient temperature variations can be included through the polarization-maintaining fiber of a single material that serves as a sensor unit.

Further, there is no need to manufacture a fiber grating as an optical fiber vibration sensor based on the fiber grating, and the polarization-maintaining fiber has a strong characteristic against transverse stress compared to a fiber grating manufactured by an ultraviolet exposing process.

The effects of the present invention are not limited to the above-described effects, and it should be understood that all possible effects deduced from a configuration of the present invention described herein and in the appended claims are included.

The above description of the invention is only exemplary, and it will be understood by those skilled in the art that various modifications can be made without departing from the scope and spirit of the present invention, and without changing the essential features thereof. Therefore, the above-described embodiments should be considered in a descriptive sense only and without limitation. For example, each component described as a single entity may be dispersed, and conversely, components described in the plural sense may also perform as a single entity thereof.

What is claimed is:

1. An optical fiber vibration sensor, comprising:
a polarization-diversity loop-based interference unit having a polarization-maintaining fiber configured to generate an interference spectrum, a polarizing beam splitter connected to the polarization-maintaining fiber and configured to split light incident from a narrowband light source into two polarized beams, and a polarization controller connected to the polarization-maintaining fiber or the polarizing beam splitter and configured to control the two polarized beams split through the polarizing beam splitter; and
an optical fiber vibration test unit combined to the polarization-maintaining fiber so as to apply an external vibration to the polarization-maintaining fiber,
wherein light output intensity of the polarization-diversity loop-based interference unit is converted to an electrical signal by a light detector, and the vibration applied to the polarization-maintaining fiber is measured through the optical fiber vibration test unit.

2. The sensor of claim 1, wherein the optical fiber vibration test unit comprises:
a piezoelectric device as a vibration source of the polarization-maintaining fiber; and
an auxiliary structure fixed to both ends of the piezoelectric device so as to transmit a vibration generated from the piezoelectric device to the polarization-maintaining fiber,
wherein the piezoelectric device is connected to a control unit using a power terminal as a medium, wherein a volume of the piezoelectric device is temporally changed according to an alternating waveform when a voltage having the alternating waveform is input from the control unit.

3. The sensor of claim 2, wherein the auxiliary structure is provided in a U-shape, wherein the auxiliary structure includes one or more materials among stainless steel, chromium (Cr), carbon (C), Teflon, iron (Fe), copper (Cu), titanium (Ti), aluminum (Al), zinc (Zn), nickel (Ni), brass, mica, and an alloy thereof.

4. The sensor of claim 1, wherein the polarization-maintaining fiber, the polarizing beam splitter, and the polarization controller are connected to each other through the optical fiber, wherein the optical fiber is connected using any one method among fusion splicing, an optical fiber patch cord, and a mechanical splicer.

5. The sensor of claim 4, wherein the optical fiber includes one or more fibers among a single-mode fiber, a multi-mode step-index fiber, a multi-mode graded-index fiber, and a high numerical aperture multi-mode fiber.

6. The sensor of claim 4, wherein the optical fiber includes one or more fibers among a silica-based fiber, a fluorine-based fiber, a rare-earth material-based fiber, a polymer-based fiber, and a flint glass fiber.

7. The sensor of claim 4, wherein the optical fiber includes one or more fibers among a photonic crystal fiber, a multi-core fiber, a twisted fiber, an etched fiber, a tapered fiber, a lensed fiber, and a metal-coated fiber.

8. The sensor of claim 4, wherein the optical fiber includes one or more fibers among a polarization-maintaining fiber, a nonlinear fiber, a dispersion-shifted fiber, a dispersion compensation fiber, and a non-zero dispersion-shifted fiber.

9. The sensor of claim 1, wherein the polarization controller includes a bulk-type polarization controller or an optical fiber-type polarization controller.

10. A method of measuring a vibration, comprising:
converting light output intensity of a polarization-diversity loop-based interference unit to an electrical signal by a light detector to measure the output intensity; and
measuring a vibration applied to the polarization-maintaining fiber through an optical fiber vibration test unit.
